(19) United States
(12) Patent Application Publication
(10) Pub. No.: US 2014/0374600 A1
(43) Pub. Date: Dec. 25, 2014

(54) Ultraviolet Sensor

(71) Applicant: Silicon Laboratories Inc., Austin, TX (US)

(72) Inventors: Jefferson L. Gokingco, Austin, TX (US); Moshe M. Altmejd, Austin, TX (US); Colin M. Tompkins, Austin, TX (US)

(21) Appl. No.: 14/307,582

(22) Filed: Jun. 18, 2014

Related U.S. Application Data
(60) Provisional application No. 61/837,037, filed on Jun. 19, 2013.

(51) Int. Cl. G01J 3/02

(52) U.S. Cl. CPC G01J 3/0297
USPC 250/340; 250/338.1; 250/349

(57) ABSTRACT

An ultraviolet radiation sensor includes an ultraviolet pass filter. A first photodiode senses light passing through the ultraviolet pass filter and provides an indication of ultraviolet light. A second photodiode provides an indication of infrared radiation. A correction circuit corrects the indication of ultraviolet light sensed by the first photodiode using the indication of infrared to account for infrared radiation that passes through the ultraviolet pass filter. Additional photodiodes may be used to correct for leakage current in the first and second photodiodes and stray infrared radiation that may affect the output of the first and second photodiodes.

This application claims benefit under 35 U.S.C. §119 of provisional application No. 61/837,037 entitled “UV Index Measurement Correction Based on Location Information,” filed Jun. 19, 2013, which application is hereby incorporated by reference.

### BACKGROUND

1. Field of the Invention

This invention relates to measuring ultraviolet radiation and improvements thereto.

2. Description of the Related Art

Ultraviolet radiation from the sun is known to be harmful. Improved access to information regarding exposure to ultraviolet radiation can be beneficial.

### SUMMARY OF EMBODIMENTS OF THE INVENTION

In an embodiment, an apparatus includes an ultraviolet pass filter to pass ultraviolet radiation from incident light received at the pass filter. A first photodiode receives light passing through the ultraviolet pass filter and supplies a first signal indicative thereof. A second photodiode sensitive to infrared radiation supplies a second signal indicative thereof. The apparatus is configured to correct for an infrared component in the first signal based on the second signal.

In an embodiment, third and fourth photodiodes are used. The third photodiode is configured with a light blocking lid to block light from reaching the third photodiode and supplies a third signal that is coupled to correct for leakage current present in the first signal supplied by the first photodiode. The fourth photodiode, configured with a light blocking cover to block light from reaching the fourth photodiode, supplies a fourth signal correct for leakage current in the second signal supplied by the second photodiode.

In another embodiment a method includes sensing ultraviolet radiation in a first photodiode after sensed light passes through an ultraviolet pass filter and generating a first indication of ultraviolet light based on the sensed ultraviolet light. A second photodiode senses infrared radiation and generates a second indication of infrared radiation based on the sensed infrared radiation. The second indication of the sensed infrared radiation is used to correct the first indication of the sensed ultraviolet light by subtracting an infrared component present in the first indication based on the second indication.

In another embodiment an ultraviolet sensor includes an ultraviolet pass filter. A first photodiode senses light passing through the ultraviolet pass filter and provides an indication of ultraviolet light. A second photodiode provides an indication of infrared radiation. A correction circuit corrects the indication of ultraviolet light sensed by the first photodiode using the indication of infrared to account for infrared radiation that passes through the ultraviolet pass filter.

### BRIEF DESCRIPTION OF THE DRAWINGS

The present invention may be better understood, and its numerous objects, features, and advantages made apparent to those skilled in the art by referencing the accompanying drawings.

FIG. 1 illustrates the Erythema weighing curve.

FIG. 2 illustrates a mobile device according to an embodiment.

FIG. 3A illustrates an example of correction curves according to an embodiment.

FIG. 3B illustrates angle from zenith.

FIG. 4 illustrates a UV sensor according to an embodiment that includes a first and second photodiode.

FIG. 5 illustrates a response of one of the photodiodes of the sensor of FIG. 4 that is sensitive to UV radiation.

FIG. 6 illustrates a response of one of the photodiodes of the sensor of FIG. 4 that is sensitive to IR radiation.

FIG. 7 illustrates an embodiment in which correction for leakage current and stray IR radiation is provided.

The use of the same reference symbols in different drawings indicates similar or identical items.

### DETAILED DESCRIPTION

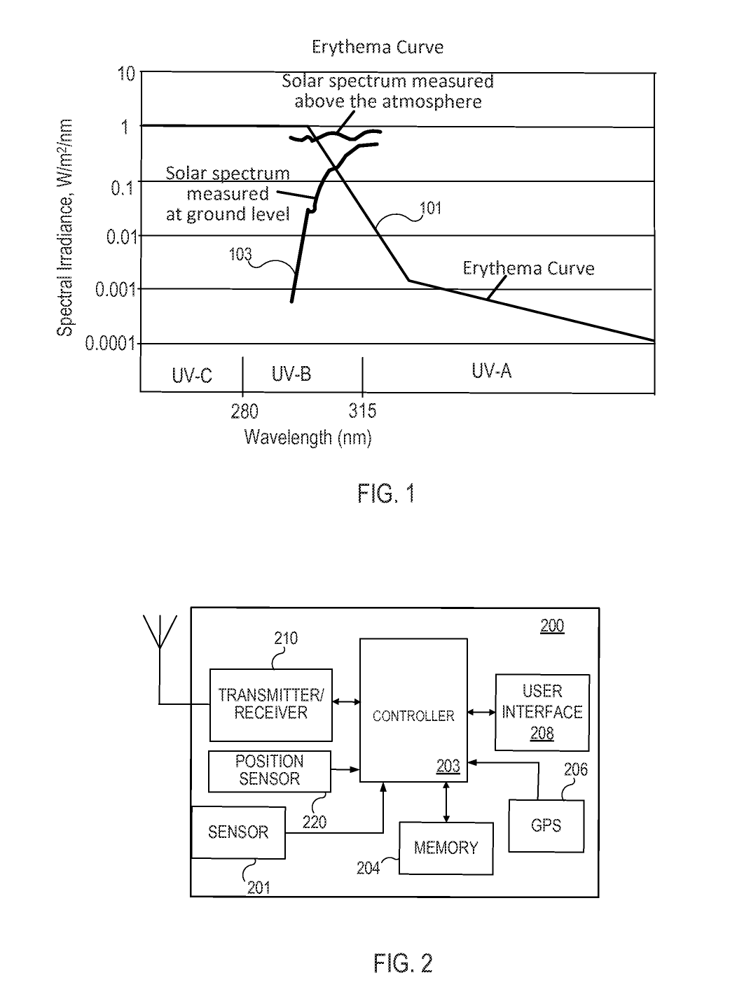

Ultraviolet (UV) index meters have the difficult task of measuring the incident light radiation while applying the Erythema weighing curve. The Erythema weighing curve 101 shown in FIG. 1 is based on the biological skin response to UV radiation at different wavelengths and is difficult to put into effect using practical sensors and filters. The curve is used to generate the UV index familiar to the public. The UV index is typically from 0 (night) to approximately 10 although higher values are possible where ozone is depleted or at high altitudes. The weighting curve takes into account the increased damage caused to humans at lower wavelengths (UV-B) as compared to higher wavelengths. Thus, UV radiation at the lower end of the UV-B spectrum, is weighted at a factor of 1, while the UV-A radiation weighting factor begins at approximately 0.013 and decreases logarithmically. The curve 103 illustrates an exemplary solar spectrum measured at ground level. That spectrum is integrated using the weighing curve of FIG. 1. As can be seen from the measured spectrum, much of UV-B is absorbed by the atmosphere before it reaches ground level. Note that to reach the familiar UV index, the integrated spectrum, using the weightings given by the Erythema curve, is divided by 25.

One way to provide good spectral response is to use a large number of diodes (e.g., made out of AlGaN material) along with filters in the light path for various wavelengths of the UV spectrum. However, that solution is too expensive in terms of material and space for an application such as a cell phone. However, many cell phones have light sensors, e.g., ambient light sensors, which allows for control of display intensity, audio, or other options that are based on the ambient light reading. Such sensors are typically made of inexpensive silicon diodes. While such sensors are useful at detecting ambient light, the sensors do not operate well at detecting UV radiation. However, an inexpensive filter can be combined with a relatively inexpensive silicon diode(s) to provide a UV sensor. That sensor would not provide particularly accurate UV readings but can be corrected using information available to a connected device such as a cell phone, which information is not available directly to the UV sensor itself.

FIG. 2 illustrates an embodiment of a device 200 that includes a UV sensor 201 that detects UV radiation and provides a measurement that can be corrected using information available to device 200 but that is not available to the sensor directly. The device 200 may be, e.g., a cell phone or other connected device (such as a tablet) or a wearable device such as a watch or bracelet. The sensor 201 is described further herein. A controller 203, typically implemented as a processor, but may be formed of or include other forms of control logic, is coupled to the UV sensor 201 and receives data from the sensor. One approach to improve the accuracy of the UV sensor data to provide a more accurate UV index reading is to use information available to the device to correct the data provided by the UV sensor. For example, the device typically includes location capability such as Global Positioning System (GPS) receiver 206. The GPS receiver 206 provides location information to the controller 203. Other location capability may also be available to the device, e.g., based on cell tower identification, or other known location techniques. That GPS reading provides location information that can be used to adjust the sensor information. Depending on the required UV Index accuracy, using the location, time of day and weather information, when used with a Photopic Ambient Light Sensor (not originally intended for use with generating a UV Index) can implement a low-cost estimate of the UV Index without significant additional cost to a device such as a cell phone, and can be used to estimate the UV Index for existing cell phones today.

One aspect of UV radiation is that the ratio of short (UV-B) to long wavelength radiation (UV-A) varies depending on location. The variation can be due to lower ozone or higher altitude that increases the ratio of short to long wavelength radiation. Thus, if a sensor is reading a broad spectrum of UV radiation including both UV-A and UV-B radiation, then the ratio of UV-B to UV-A is important in trying to accurately utilize the Erythema curve. One correction approach described herein takes the measurements made by imperfect sensor(s) and by using location information, which includes latitude, longitude and altitude, corrects for the ratio of short (UV-B) and long wavelength radiation (UV-A) expected in the particular location. For example, for locations that close to the extreme southern latitudes, such as at the tip of south America and in Antarctica, the UV-B portion increases and a UV index reading from the meter would need to be corrected up, for example, from 10.0 to 10.5. The same phenomenon happens with increasing altitude. Thus, a sensor reading from the device while located in Denver, Colo. at approximately 5000 feet would need to be corrected for altitude whereas a sensor reading from the device located, e.g., near sea level would not need location correction. UV measurements in the general location of the device or forecasted UV levels obtained from other sources on the World Wide Web can also be used to help make this correction and as a further check on the accuracy of the reading. In addition, the UV reading from the handset can be uploaded into a data base that can be shared with other users. Weather information in general can be retrieved by the device through the transmitter/receiver 210. That retrieval can utilize various communication protocols such as Long Term Evolution (LTE) or 802.11n (WiFi) commonly found on cell phones and other communication devices. The weather information can include UV index forecasts, cloud cover forecasts, atmospheric pressure, and any other information (e.g., pollution forecasts) that could be useful in verifying and/or adjusting the measured ultraviolet radiation from the UV sensor located on the communication device to match the accepted approach to reporting UV radiation illustrated in the Erythema curve shown in FIG. 1.

The UV-A/UV-B/Visible/IR proportions change when there are clouds in the sky, even when the clouds do not block the sun. Thus, if the UV index reading is high, e.g., 8 and weather data indicates a cloudy day, the index reading can be increased to 9 to reflect under-sensing of the UV due to the clouds. Silicon sensors are more accurate in evaluating the UV in sunlight in sunny situations and thus the weather information can help correct for the cloudy situations. Statistical studies have indicated errors due to clouds falling into two groups, the first where the UV index is over-read and the second where the UV index is under read. The two groups of errors can be correlated to different cloud types and generate a better correction.

In another example of using weather information for correction, the ozone distribution is a weather phenomenon and when available can be used to adjust the UV reading from the sensor. Ozone is more effective in screening out UV-B to which the photodiode is less sensitive. Thus, ozone information can be used for correction.

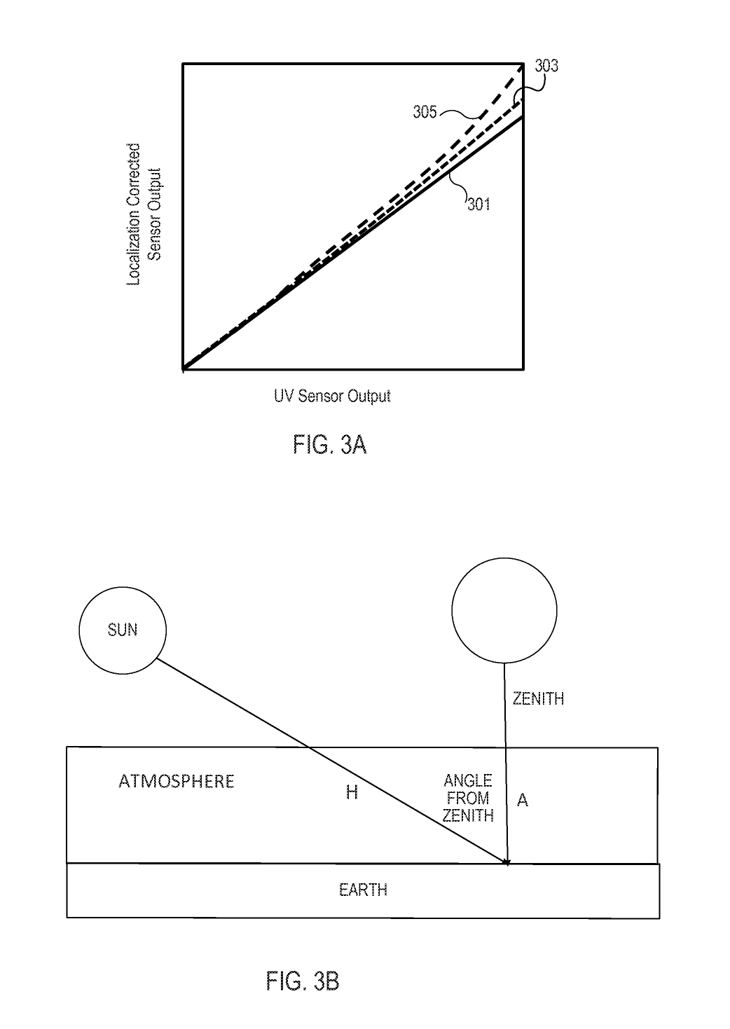

FIG. 3A illustrates an exemplary correction curve to the sensor output. Curve 301 is the uncorrected curve. Curve 303 shows a mild correction, e.g., for sensor data from a moderate altitude and high ozone location. Curve 305 shows a more pronounced correction, e.g., for sensor data from a high altitude and low ozone location. The curves are non-linear on the assumption that lower sensor output correlates with UV-B attenuation due to the sun being far from zenith.

The zenith angle is shown in FIG. 3B. The zenith angle is the angle of the sun relative to the imaginary line (zenith) that goes ‘straight up’ perpendicular to the surface of the earth. As an illustration, during sunset or sunrise, the zenith angle is at its peak. The zenith angle is very low at noon but non-zero in the United States. In the United States at noon, the sun's angle relative to “straight up” is around 17 degrees. The angle can be higher in Europe since they are generally at higher latitude relative to the United States. If you are on the equator, it is possible to have a zenith angle of zero degrees. The larger the zenith angle, the higher the Air Mass Index is. The higher the Air Mass Index, the lower the percentage of UV becomes with respect to the rest of the sunlight spectrum.

FIG. 3B is of course an approximation since it does not allow for the curvature of the earth. Clouds also modify the model somewhat. In FIG. 3B A/H=cosine (angle from zenith). H/A=1/cosine (angle from zenith), is a factor that multiplies the spectral attenuation in the atmosphere due to the longer travel path. Green light (550 nm) passes through almost regardless of angle but regions of the spectrum attenuated by ozone, moisture, and/or other gasses do not.

One of the challenges for UV index generation is to make a distinction between a ‘cloudy day’ versus being ‘indoors and under low-emissivity (low-E) glass’. The location, time, and weather information can be used to determine whether or not the device is indoors or outdoors. If the sensor reading is lower than expected given weather information, location, and time of day, it could mean that the device is indoors and behind Low E glass. Besides providing location information, the existence or signal strength of a GPS signal can be used to help determine if the sensor is indoors or outdoors. For example, an indication that the device is indoors can be based on GPS information not being present and weather data indicating clear skies.

Given the time of day and location, it is possible to determine the Air Mass Index. The Air Mass Index denotes how much of the atmosphere is present outdoors. The higher the Air Mass Index, the lower the percentage of UV becomes with respect to the rest of the sunlight spectrum. Even without the actual sensor measurement, it is possible to estimate the ‘maximum’ UV Index. If the sensor is not getting anywhere near the maximum, then it can be assumed that it is either cloudy or the UV Sensor is being measured indoors, but behind a low-E glass. If the weather information says that it is ‘clear skies’, then one assumption that can be made is that the device is operating indoors but behind low-E glass.

Thus, other relevant information includes time of day. The time of day determines the zenith angle of the sun. Early or late in the day increases the attenuation of UV radiation. The corrections based on location and time of day can be stored as equations in the memory 204 (see FIG. 2). The correction may thus use the sensor output, the time of day corresponding to sun angle, and location (providing latitude, longitude, and altitude) to provide a more accurate UV index reading than otherwise available without the correction.

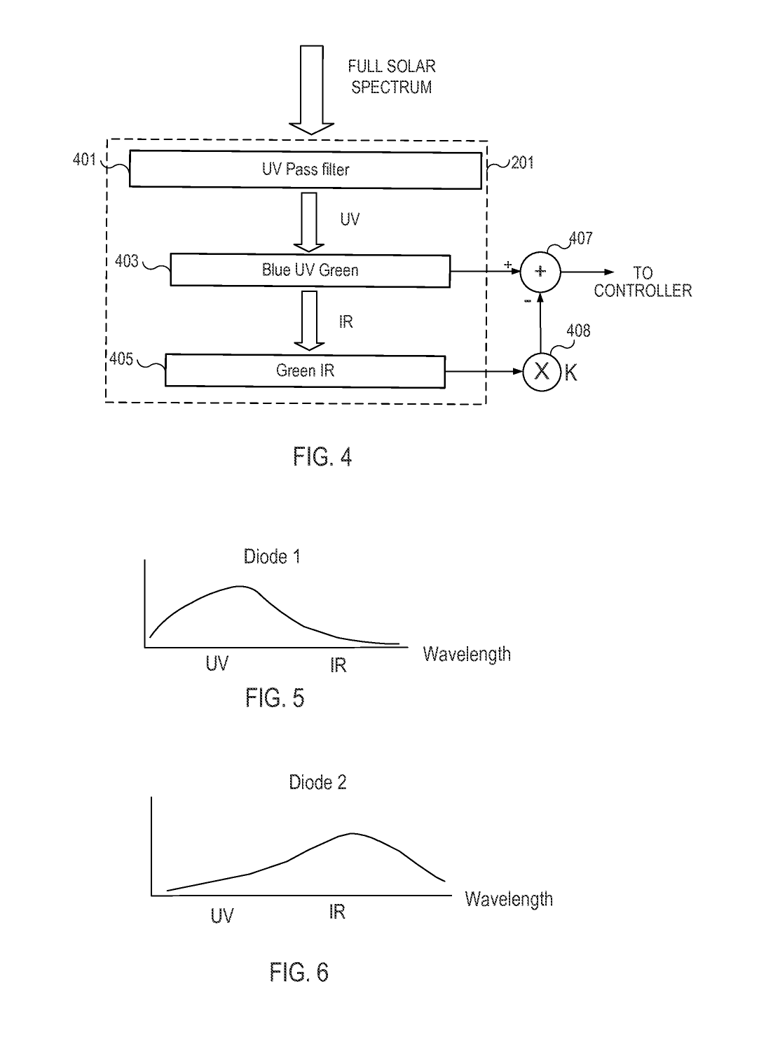

FIG. 4 shows additional details of an embodiment of sensor 201. In the embodiment of FIG. 4, a UV pass filter 401 is placed above a stacked photodiode pair 403 and 405. The UV filter 401 blocks light other than UV, although the filter is imperfect and some light other than UV passes through the filter. For example, many UV pass filters leak infrared (IR) radiation. The filtered light is provided to a first diode 403 that is close to the surface and sensitive to visible light, e.g., blue green and UV radiation. With significant portions of the visible spectrum filtered, FIG. 5 shows an exemplary response curve of the first photodiode 403. As shown, the first photodiode is sensitive to UV radiation and has some sensitivity to infrared (IR) radiation. The first photodiode's sensitivity peaks towards the UV end of the visible spectrum and thus provides a signal indicative of UV but includes some error due to the imperfect nature of the UV pass filter and due to signals that may bypass the pass filter entirely. A second diode 405 is vertically displaced from the first diode 403 and is sensitive to infrared (IR) radiation and has some sensitivity to UV. The silicon between photodiode 403 and photodiode 405 functions as an optical filter. Light is absorbed by the silicon partly in the process of converting photons energy to the energy in electron hole pairs. The typical “absorption coefficient” in silicon varies with wavelength. The absorption coefficient reflects the average distance that photons of different wavelengths travel before absorption. Since shorter wavelengths are absorbed near the surface one can say the front layers of silicon have filtered out light of that wavelength.

FIG. 6 shows an exemplary response curve of the second photodiode 405. The second photodiode's sensitivity peaks at longer wavelengths than the first photodiode and supplies a signal with more relative error than the first photodiode. In order to account for the portion of the output of the first photodiode due to IR radiation, the second diode can be used to determine the IR content and subtract out the IR content from the output of the first photodiode. The response of the first photodiode 403 may be provided to a subtraction circuit 407 that subtracts the IR response of photodiode 405 from the UV response of photodiode 403 after the IR response of photodiode 405 is scaled by a factor K in multiplier 408. The scale factor K is based on how much of the signal provided by photodiode 405 should be used to correct the output of photodiode 403. That corrected sensor reading may then be provided to the controller 203. Alternatively, both photodiode readings may be provided to the controller 203 in digital form, and the controller 203 corrects the output of photodiode 403 for the IR radiation component that is present. Note that while FIG. 4 shows stacked photodiodes, in other embodiments the diodes are not stacked.

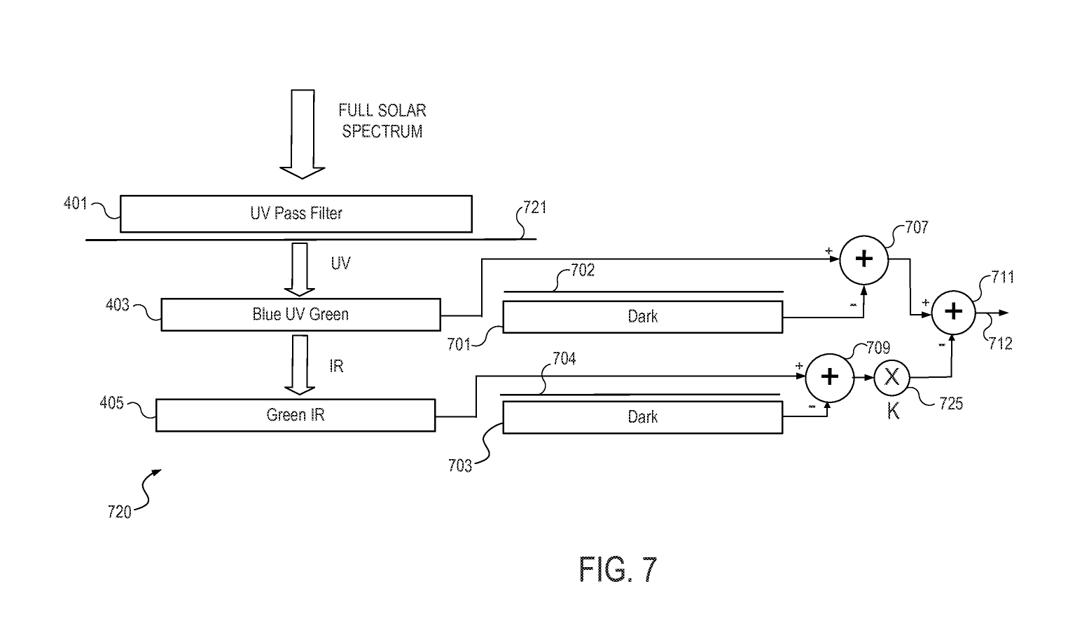

FIG. 7 illustrates another embodiment in which a second pair of stacked photodiodes 701 and 703 operate with the first pair of stacked photodiodes 403 and 405 to provide improved accuracy in UV measurement. The diodes 701 and 703 include light blocking covers 702 and 704 that prevent light from reaching the diodes from the top, hence are referred to herein as “dark” photodiodes. Photodiodes that are properly biased supply current in the presence of light, but even without the presence of light there is some leakage current. The covered (or dark) diodes 701 and 703 are used to detect that leakage current and as explained below, the current generated by diodes 701 and 703 may be used to correct the ultraviolet measurement for the leakage current. In addition, stray infrared radiation may enter the integrated circuit from the sides. The infrared radiation may create a charge carrier pair at the depletion region of the diodes. In another mechanism, the stray photon may cause a charge carrier pair at a distance from the depletion region of the diode but the charge carrier pair may travel to the depletion region through the bulk region of the semiconductor device. In either case, additional current may be generated in diodes 403 and 405 and diodes 701 and 703 that are caused by the stray infrared radiation.

FIG. 7 illustrates a block diagram of the correction mechanism that may be utilized with dark diodes 701 and 703. In the illustrated embodiment, the output signals of photodiodes 403 and 701 are supplied to a summer 707, which subtracts the output of photodiode 701 from the output of photodiode 403. That subtraction corrects for both leakage current and stray IR radiation that is responsible for a portion of the current generated by photodiode 403. It is assumed the photodiodes 403 and 701 have similar leakage current and exposure to stray IR radiation from the sides of the integrated circuit. In an embodiment the diodes 403 and 701 are at a similar depth in the integrated circuit. In addition, the output signal of photodiode 405, which is used to measure IR radiation leaking through the UV pass filter 401, is supplied to summer 709, which also receives the output signal from photodiode 703. It is assumed the photodiodes 405 and 703 have similar leakage current and exposure to stray IR radiation from the sides of the integrated circuit. In an embodiment the photodiodes 405 and 703 are at a similar depth. The output signal from photodiode 703 is subtracted from the output signal from photodiode 405 to correct for additional current present in the output of photodiode 405 caused by leakage current and stray IR radiation. Finally, the corrected IR measurement supplied by summer 709 is scaled in multiplier 725 by a scale factor K and the scaled corrected IR measurement is subtracted from the corrected UV measurement supplied by summer 707 in summer 711, which supplies an output signal 712 that is the UV measurement corrected for IR radiation that leaks through UV pass filter 401 and for leakage current and/or stray IR radiation.

Note that the block diagram shown in FIG. 7 is one embodiment and other embodiments are possible. For example, the corrections for leakage IR radiation, stray IR radiation, and/or leakage current may be done in the digital domain, e.g., in controller 203, when, e.g., controller 203 is a processor. A digital correction embodiment requires analog to digital converters (not shown) to convert the output signals of the photodiodes to digital signals before the subtractions illustrated in FIG. 7 are performed. After conversion to digital, the corrections shown in FIG. 7 may be implemented in software operating on the processor 203 or on other digital subtraction circuits. Thus, the subtraction operations illustrated in FIG. 7 may represent digital subtraction circuits. Note that the order of subtractions may be changed as long as the final output represents the corrections desired. One embodiment may only correct for IR radiation that leaks through the ultraviolet filter, such as the embodiment shown in FIG. 4, while other embodiments may include appropriate subtractions to account for leaking IR, stray IR, and leakage current.

The UV pass filter 401 may be implemented as a multi-layer interference filter directly sputtered onto an oxide or nitride layer 721 of integrated circuit 720 above the photodiodes 403, 405, 701, and 703, which are disposed in integrated circuit 720. In other embodiments, the UV pass filter 401 may be formed as an interference filter on a glass substrate and mechanically attached to the integrated circuit 720. The interference filters are typically made by stacking 10 to 100 layers having varying dielectric constants. Thin metal layers may be used as well.

UV index measurements are typically made by pointing the sensor to zenith and integrating the light from the entire view of the sky. Since portable devices often prevent that mode of operation by limiting the sensor to a small peephole with a narrow angle of view of typically +/−30 degrees, in one embodiment the UV sensor is pointed at the sun during sensing instead of zenith since the sun is the dominant source of the UV. The information from the position sensor 220 in the mobile device is then used to correct the reading. For example, if the position sensor reports a 45 degree angle from zenith when measuring UV, the measurement controller, e.g., controller 203, assumes the user is pointing at the sun at 45 degrees and multiplies the apparent reading by the cosine of 45 degrees (0.707). That adjustment based on information from the position sensor results in a more accurate UV index reading.

The description set forth herein is illustrative, and is not intended to limit the scope of the invention as set forth in the following claims. Variations and modifications of the embodiments disclosed herein may be made based on the description set forth herein, without departing from the scope and spirit of the invention as set forth in the following claims.

What is claimed is:

1. An apparatus comprising:
an ultraviolet pass filter coupled to receive incident light;
a first photodiode coupled to receive light passing through the ultraviolet pass filter and to supply a first signal indicative thereof; and
a second photodiode sensitive to infrared radiation to supply a second signal indicative thereof,
wherein the apparatus is configured to correct for an infrared component in the first signal based on the second signal.

2. The apparatus as recited in claim 1 wherein the second photodiode is disposed to receive infrared radiation that passes through the ultraviolet pass filter.

3. The apparatus as recited in claim 1 wherein the second photodiode is vertically displaced from the first photodiode.

4. The apparatus as recited in claim 1 further comprising:
a third photodiode configured with a light blocking cover to block light from reaching the third photodiode and supplying a third signal; and
wherein the third signal of the third photodiode is coupled to correct for leakage current present in the first signal supplied by the first photodiode.

5. The apparatus as recited in claim 4 further comprising:
a fourth photodiode configured with a light blocking cover to block light from reaching the fourth photodiode and to supply a fourth signal; and
wherein the fourth signal of the fourth photodiode is coupled to correct for leakage current present in the second signal supplied by the second photodiode.

6. The apparatus as recited in claim 5 wherein third and fourth photodiodes are disposed at respective levels of the first and second photodiodes in an integrated circuit in which the first, second, third, and fourth photodiodes are disposed.

7. The apparatus as recited in claim 5 wherein third and fourth photodiodes are vertically stacked.

8. The apparatus as recited in claim 5 wherein the apparatus is configured to correct the first signal from the first photodiode using the third signal generated by the third photodiode and generate a fifth signal and the device is further configured to correct the second signal from the second photodiode using the fourth signal generated by the fourth photodiode and generate sixth signal and the device is further configured to correct the fifth signal using the sixth signal and as an indication of ultraviolet radiation.

9. The apparatus as recited in claim 1 wherein the ultraviolet pass filter is sputtered on an insulating layer of an integrated circuit in which the first and second photodiodes are disposed.

10. The apparatus as recited in claim 1 wherein the ultraviolet pass filter is formed on glass and mechanically coupled to the integrated circuit in which the first and second photodiodes are disposed.

11. The apparatus as recited in claim 1 wherein the apparatus is a portable device.

12. A method comprising:
sensing ultraviolet radiation in a first photodiode after sensed light passes through an ultraviolet pass filter and generating a first indication of ultraviolet light based on the sensed ultraviolet light;
sensing infrared radiation in a second photodiode and generating a second indication of infrared radiation based on the sensed infrared radiation; and
using the second indication of the sensed infrared radiation to correct the first indication of the sensed ultraviolet light.

13. The method as recited in claim 12 wherein the correcting comprises subtracting an infrared component present in the first indication based on the second indication.

14. The method as recited in claim 12 wherein generating the first indication further comprises using an output from a third photodiode with a light blocking cover to block light from reaching the third photodiode, to correct for leakage current present in an output of the first photodiode.

15. The method as recited in claim 14 wherein generating the second indication further comprises using an output from a fourth photodiode with a light blocking lid to block light from reaching the fourth photodiode, to correct for leakage current present in an output of the second photodiode.

16. The method as recited in claim 12 further comprising:
pointing a sensor opening of a device in which the first and second photodiodes are disposed at the sun while sensing the ultraviolet radiation;
determining position information of the device during the pointing; and
adjusting the first indication of the sensed ultraviolet light based on the position information.

17. An ultraviolet sensor comprising:
an ultraviolet pass filter;
a first photodiode to sense light passing through the ultraviolet pass filter and provide an indication of ultraviolet light;
a second photodiode to provide an indication of infrared radiation passed by the ultraviolet pass filter; and
a correction circuit to correct the indication of ultraviolet light based on the indication of infrared.

18. The ultraviolet sensor as recited in claim 17 further comprising a third photodiode configured to provide a first leakage current indication and a fourth photodiode configured to provide a second leakage current indication.

19. The ultraviolet sensor as recited in claim 18 wherein the correction circuit is further configured to correct the indication of ultraviolet light based on the first leakage current indication and to correct the indication of infrared based on the second leakage current indication.

20. The ultraviolet sensor as recited in claim 17 wherein the first and second photodiodes are in a stacked arrangement.

21. The ultraviolet sensor as recited in claim 18 wherein the third and fourth photodiodes are in a stacked arrangement.
